(19) United States
(12) Patent Application Publication
(10) Pub. No.: US 2021/0100354 A1
(43) Pub. Date: Apr. 8, 2021

(54) HEIGHT-ADJUSTABLE TABLE

(71) Applicant: LINAK A/S, Nordborg (DK)

(72) Inventor: Anne STAER MØLLER, Senderborg (DK)

(21) Appl. No.: 16/499,551

(22) PCT Filed: May 15, 2018
(86) PCT No.: PCT/DK2018/000015

§ 371 Date: Sep. 30, 2019

(30) Foreign Application Priority Data
May 15, 2017 (DK) PA 2017 00305

(51) Int. Cl. A47B 9/20

(52) U.S. Cl. CPC A47B 9/20; A47B 2220/0075; A47B 2200/0062

(57) ABSTRACT

The present invention relates to a height-adjustable table (1) which can assist and motivate the user to use the height-adjustable table in a manner which increases health and well-being.

The present invention relates to a height-adjustable table and methods for operating such a table. Height-adjustable tables are also known as sit/stand desks.

A common height-adjustable table comprises a frame to which a table top is mounted. The frame is attached to one end of at least one linear actuator in the form of a lifting column. A foot is mounted to the other end of the lifting column. As examples of these types of lifting columns reference is made to WO/2004/040169 A1 and WO 2009/033486 A1 both LINAK A/S.

Although height-adjustable tables comprising a linear actuator system are becoming more widespread, it is a fact that many users do not make use of its most obvious functionality, i.e. the height-adjustment. This is in contrast to the known benefits that movement during the day has for health, especially for our metabolism. Standing and moving burns more calories than sitting and engages the leg muscles of the user. Besides the higher calorie burn when standing it is also proven that standing and moving during the day improves circulation, energy, stress and overall well-being of the user. Just the act of going from a seated position to a standing position forces the body to work against gravity and helps strengthen our stabilizer muscles. In general it is recommended that sedentary workers mix sitting and standing during an average workday—sitting or standing for no longer than one hour before changing position. A recommended goal is to strive for an extra 120 minutes of standing during a workday and to change postures at least 8 to 16 times.

The objective of the invention is to provide an improved height-adjustable table which can assist and motivate the user to use the height-adjustable table in a manner which increases health, calorie burn and well-being.

According to the invention this is solved by providing a height-adjustable table comprising at least one electric linear actuator, a controller for controlling the at least one linear electric actuator, a system for determining the actual height adjustment level of the adjustable table associated with the controller and providing input information to the controller about the actual height adjustment level of the adjustable table, an operating unit connected to the controller for user activation requesting an adjustment of the height level of the table by supplying the at least one linear actuator from an appropriate source of electrical energy. The controller comprises a memory for storing at least one height adjustment setting referring to a sitting position or a standing position. The controller comprising a timer device adapted to monitor the time for which the height adjustment setting has been in its present state, the states referring to a sitting position or a standing position. The controller comprising a memory for storing a predetermined programmable timer value for reminding the user to adjust the height of the height-adjustable table from the height adjustment setting, referring to a sitting position to a standing position or vice versa. The controller continuously compares the timer value obtained by the timer device with the predetermined programmable timer value and further calculates a value expressing the progress towards time-out of the predetermined programmable timer value. The height-adjustable table further comprises a light emitting arrangement, where the light emitting arrangement is adapted to emit light within a range of wavelengths starting with a first wavelength and ending with a second wavelength. The light emitting arrangement is adapted to emit light with a wavelength within the range of the wavelengths corresponding to the value expressing the progress towards time-out of the timer value.

In an embodiment of the height-adjustable table a time interval is defined as a range from the timer value to time-out of the timer value, and where the time interval is mapped into the range of wavelengths of the light emitting arrangement, such that the timer value corresponds to the first wavelength of the range of wavelengths and time-out of the timer value corresponds to the second wavelength of the range of wavelengths.

In an embodiment of the height-adjustable table a time interval is defined as a range from the timer value to time-out of the timer value, and where the time interval is divided into at least two sub time intervals, where each sub time interval corresponds to a specific wavelength on the range of wavelengths.

In an embodiment of the height-adjustable table, the light emitting arrangement emits light with a wavelength within the range of the wavelengths in an intermittent manner.

In an embodiment of the height-adjustable table the controller comprises three sub time intervals, where each sub time interval corresponds to a wavelength emitting a green, orange, and red color, respectively.

In an embodiment of the height-adjustable table, the wavelength emitted by the light emitting arrangement changes color in a fluent transition from green, over orange to red.

In an embodiment of the height-adjustable table, the light emitting arrangement emits a wavelength outside the range of wavelengths to indicate a special state of the controller.

In an embodiment of the height-adjustable table, the first wavelength corresponds to a wavelength of approximately 500 nanometers and the second wavelength corresponds to a wavelength of approximately 700 nanometers.

In an embodiment of the height-adjustable table, the light emitting arrangement is arranged in the operating unit.

In an embodiment of the height-adjustable table, the height-adjustable table comprises a table top in which the light emitting arrangement is arranged.

An embodiment of the invention will be described more fully below with reference to the accompanying drawing, in which:

FIG. 1 shows a perspective view of a height-adjustable table,

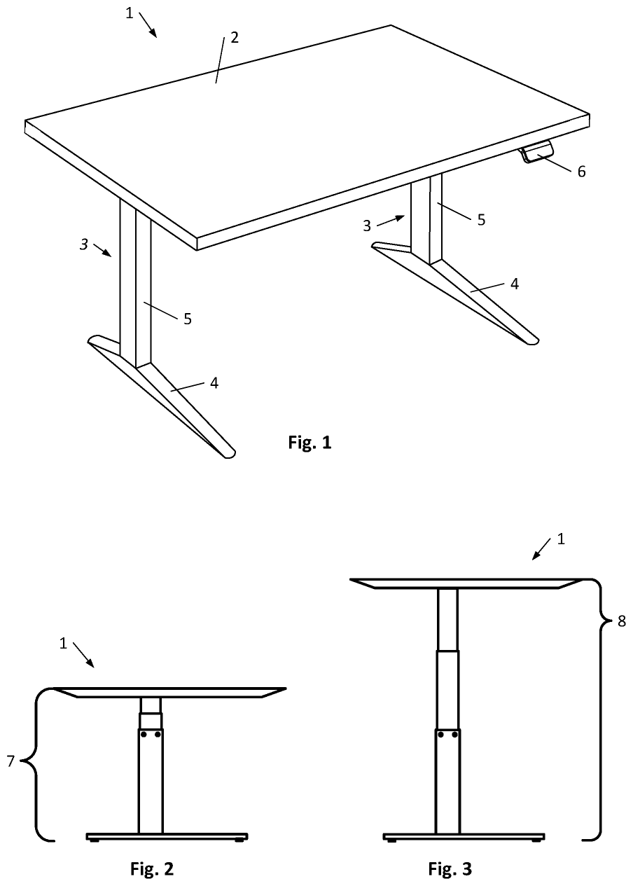

FIG. 2 illustrates a height-adjustable table in a sitting position,

FIG. 3 illustrates the height-adjustable table in a standing position,

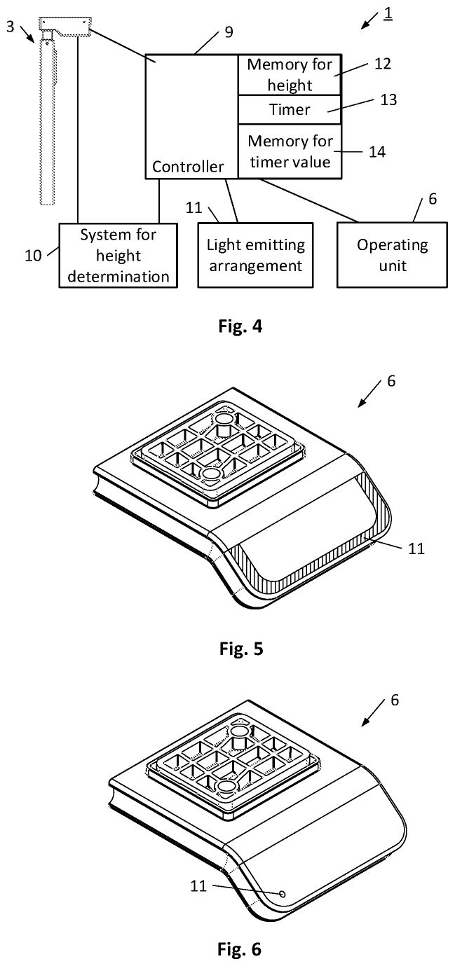

FIG. 4 is a schematic diagram of the height-adjustable table,

FIG. 5 is a perspective view of the operating unit comprising a light guide,

FIG. 6 is a perspective view of the operating unit comprising a light diode,

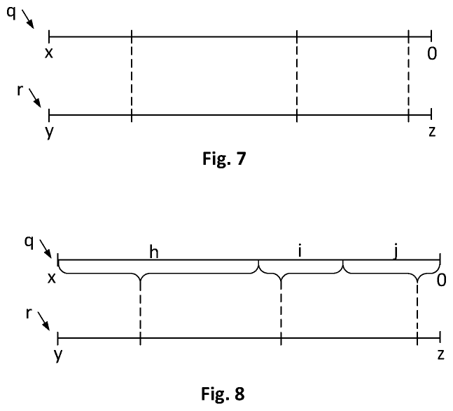

FIG. 7 schematically illustrates a mapping of a time interval q into a range of wavelengths, and

FIG. 8 schematically illustrates a mapping of a time interval divided into sub time intervals into a range of wavelengths.

FIG. 1 shows a perspective view of a height-adjustable table 1 comprising a table top 2. At each side of the height-adjustable table 1 a linear actuator in the form of a lifting column 3 is mounted in a carrying frame (not shown) onto which the table top 2 is mounted. The other end of each lifting column 3 comprises a foot 4 on which the height-adjustable table 1 stands. The lifting columns 3 comprise a drive unit (not shown) and two or three mutually telescopically arranged profiles. One profile 5 is stationary fixed to the foot 4 and one profile (not referenced) is stationary fixed to the motor housing. Each lifting column 3 is driven by means of an electric motor, which through a gear drives a spindle. The spindle is furnished with a spindle nut secured to the telescopically movable profile(s). The height-adjustment of the table top 2 is thus performed by the lifting columns 3. The adjustment is achieved by activating the operating unit 6.

FIGS. 2 and 3 illustrate a side view of the height-adjustable table 1 in a sitting position 7 and a standing position 8, respectively. Since the length of the lifting columns 3 can be adjusted, the sitting position 7 and standing position 8 can be set to accommodate the physical characteristics and personal preferences of each individual user of the height-adjustable table 1.

FIG. 4 depicts a schematic view of the height-adjustable table 1 comprising a linear actuator 3, a controller 9, a system 10 for determining the actual height adjustment level of the height-adjustable table 1, an operating unit 6, and a light emitting arrangement 11.

The system 10 for determining the actual height adjustment level could be determined by potentiometers or Hall sensors built into the linear actuators 3 or by other detection means such as an optical sensor. The system 10 for determining the actual height adjustment level provides input information about the actual height adjustment level to the controller 9.

The operating unit 6 is connected to the controller 9 for user activation requesting an adjustment of the height level of the height-adjustable table 1 by supplying the at least one linear actuator 3 from an appropriate source of electrical energy (not shown).

The controller 9 comprises a memory 12 for storing at least one height adjustment setting 7,8 referring to a sitting position 7 or a standing position 8. The controller 9 further comprises a timer device 13 adapted to monitor the time for which the height adjustment setting 7,8 has been in its present state, the states referring to a sitting position 7 or a standing position 8. The timer device 13, in other words, determines the elapsed time in which the height-adjustable table 1 has been in a sitting position 7 or a standing position 8.

The controller 9 further comprises a memory 14 for storing a predetermined programmable timer value for reminding the user to adjust the height of the height-adjustable table from the height adjustment setting 7,8 referring to a sitting position 7 to a standing position 8 or vice versa. The controller 9 continuously compares the timer value obtained by the timer device 13 with the predetermined programmable timer value of the memory 14.

The controller 9 is adapted to calculate a value expressing the progress towards time-out of predetermined programmable timer value of the memory 14.

The light emitting arrangement 11 is adapted to emit light within a range of wavelengths r starting with a first wavelength z and ending with a second wavelength y. The light emitting arrangement 11 is adapted to emit light with a wavelength within the range of the wavelengths corresponding to the value expressing the progress towards time-out of the timer value.

As schematically illustrated in FIG. 7, the controller 9 defines a time interval q as a range from the timer value x to time-out of the timer value x. The time interval q is mapped into the range of wavelengths r of the light emitting arrangement 11, such that the timer value x corresponds to the first wavelength z of the range of wavelengths r, and the time-out of the timer value corresponds to the second wavelength y of the range of wavelengths r. In this way each value of the time interval q is converted into a wavelength on the range of wavelengths r. The wavelength emitted by the light emitting arrangement 11 can change color in a fluent transition from green, over orange to red. The first wavelength (a) could correspond to a wavelength of approximately 500 nanometers and the second wavelength (b) corresponds to a wavelength of approximately 700 nanometers.

The time interval q of the controller can also be divided into at least two sub time intervals h,i,j such that each sub time interval h,i,j corresponds to a specific wavelength on the range of wavelengths r. As illustrated schematically in FIG. 8, time interval q of the controller 9 is divided into the three sub time intervals h,i,j such that each sub time interval h,i,j corresponds to a wavelength emitting a green, orange, and red color, respectively. This simplifies the number of states that users of the height adjustable table needs to relate to.

In order to remind the user to adjust the height of the height adjustable table 1 the light emitting arrangement 11 can emit light with a wavelength within the range of the wavelengths r in an intermittent manner. This is meant to catch the attention of the user and prompt her or him to adjust the height-adjustable table 1.

To indicate to the user that the controller 9 is in a special state, the light emitting arrangement 11 can emit a wavelength outside the range of wavelengths r. A special state could for example be an indication of a successful Bluetooth pairing, successful storing of a height adjustment setting (standing position and/or sitting position).

As shown in FIG. 5 the light emitting arrangement 11 can be a light guide arranged in the operating unit 6. The light emitting arrangement 11 can also be arranged in the operating unit 6 as a small diode, as shown in FIG. 6. Alternatively the light emitting arrangement 11 can be arranged in the table top 2 of the height adjustable table 1.

1. A height-adjustable table (1) comprising
at least one electric linear actuator (3),
a controller (9) for controlling the at least one linear electrical actuator (3),
a system for determining the actual height adjustment level of the adjustable table associated with the controller (9) and providing input information to the controller (9) about the actual height adjustment level of the adjustable table,
an operating unit (6) connected to the controller (9) for user activation requesting an adjustment of the height level of the table by supplying the at least one linear actuator (3) from an appropriate source of electrical energy,
the controller (9) comprising
a memory (12) for storing at least one height adjustment setting (7,8) referring to a sitting position or a standing position,
the controller (9) comprising a timer device (13) adapted to monitor the time for which the height adjustment setting (7,8) has been in its present state, the states referring to a sitting position or a standing position,
the controller (9) comprising a memory (14) for storing a predetermined programmable timer value for reminding the user to adjust the height of the height-adjustable table from the height adjustment setting (7,8) referring to a sitting position to a standing position or vice versa,
and where the controller (9) continuously compares the timer value obtained by the timer device (13) with the predetermined programmable timer value and further calculates a value expressing the progress towards time-out of the predetermined programmable timer value, and
where the height-adjustable table (1) further comprises a light emitting arrangement (11),
where the light emitting arrangement (11) is adapted to emit light within a range of wavelengths starting with a first wavelength (a) and ending with a second wavelength (b),
where the light emitting arrangement (11) is adapted to emit light with a wavelength within the range of the wavelengths corresponding to the value expressing the progress towards time-out of the timer value.

2. The height-adjustable table (1) according to claim 1, wherein a time interval (q) is defined as a range from the timer value (x) to time-out of the timer value (x), and where the time interval (q) is mapped into the range of wavelengths of the light emitting arrangement, such that the timer value (x) corresponds to the first wavelength (a) of the range of wavelengths and time-out of the timer value corresponds to the second wavelength (b) of the range of wavelengths.

3. The height-adjustable table (1) according to claim 1, wherein a time interval (q) is defined as a range from the timer value (x) to time-out of the timer value (x), and where the time interval (q) is divided into at least two sub time intervals (h,i,j) and where each sub time interval (h,i,j) corresponds to a specific wavelength on the range of wavelengths.

4. The height-adjustable table (1) according to claim 3, wherein the light emitting arrangement (11) emits light with a wavelength within the range of the wavelengths in an intermittent manner.

5. The height-adjustable table (1) according to claim 3, wherein the controller (9) comprises three sub time intervals (h,i,j) and where such sub time interval (h,i,j) corresponds to a wavelength emitting a green, orange, and red color, respectively.

6. The height-adjustable table (1) according to claim 1, wherein wavelength emitted by the light emitting arrangement (11) change color in a fluent transition from green, over orange to red.

7. The height-adjustable table (1) according to claim 1, wherein the light emitting arrangement (11) emits a wavelength outside the range of wavelengths to indicate a special state of the controller (9).

8. The height-adjustable table (1) according to claim 1, wherein the first wavelength (a) corresponds to a wavelength of approximately 500 nanometers and that the second wavelength (b) corresponds to a wavelength of approximately 700 nanometers.

9. The height-adjustable table (1) according to claim 1, wherein the light emitting arrangement is arranged in the operating unit (6).

10. The height-adjustable table (1) according to claim 1, wherein the height-adjustable table comprises a table top (2) in which the light emitting arrangement is arranged.
